(19) United States
(12) Patent Application Publication
(10) Pub. No.: US 2007/0059405 A1
(43) Pub. Date: Mar. 15, 2007

(54) Liquid sweetener and packaging

(76) Inventor: Darren Segal, Encino, CA (US)

Correspondence Address: YING CHEN, 255 S. GRAND AVE., # 215, LOS ANGELES, CA, 90012, US

(21) Appl. No.: 11/519,991

(22) Filed: Sep. 11, 2006

Related U.S. Application Data
(60) Provisional application No. 60/716,431, filed on Sep. 12, 2005.

(51) Int. Cl. A23B 7/148

(52) U.S. Cl. 426/106

(57) ABSTRACT

One aspect of the present invention is a liquid packet as packaging for liquid sweetener. The liquid packet has a generally planner or cylindrical construction with seals at appropriate locations. The liquid packet is sized to deliver a sweetness level of at least one teaspoon (1 tsp.) of sugar. Another aspect of the invention is a liquid packet having a pour spout and a tear notch. Preferably, the spout and tear notch are located near a corner of the liquid packet and allows for pouring of the content from the spout after a top section of the packet material is partially torn without completely tearing off a piece of the packet. An optional leak-prevention feature may be provided to prevent the remnants of the liquid from leaking out easily after the packet is opening and not all the liquid is used.

This application claims priority from U.S. Provisional Patent Application No. 60/716,431, filed Sep. 12, 2005, which is herein incorporated by reference in its entirety.

### BACKGROUND OF THE INVENTION

The present invention relates to packaging for a liquid sweetener.

### SUMMARY OF THE INVENTION

One aspect of the present invention is a liquid packet as packaging for liquid sweetener. The liquid packet has a generally planner construction with seals at appropriate locations.

Another aspect of the invention is a liquid packet having a pour spout and one or more tear notches. Preferably, the spout and tear notch(es) are located near a corner of the liquid packet and allows for easy pouring of the content from the spout after a top section of the packet material is partially torn without completely tearing off a piece of the packet.

The liquid packet is sized to deliver a sweetness level of at least one teaspoon (1 tsp.) of sugar. The approximate dimensions of the packaging described below and the formed and filled area may be designed according to this dosage.

### BRIEF DESCRIPTION OF THE DRAWINGS

FIGS. 1-11 illustrate various liquid packets according to embodiments of the present invention.

### DETAILED DESCRIPTION OF THE PREFERRED EMBODIMENTS

The liquid sweetener according to embodiments of the present invention is an alternative to granulated sugar and to sugar substitutes, such as Sweet N' Low, a trademark of Cumberland Packing Corp. The main function of the liquid sweeteners is to sweeten food and beverages. The sweeteners may be used in iced tea, iced coffee, hot tea, espresso drinks, lemonade, cocktails, over fruit, cereal, etc.

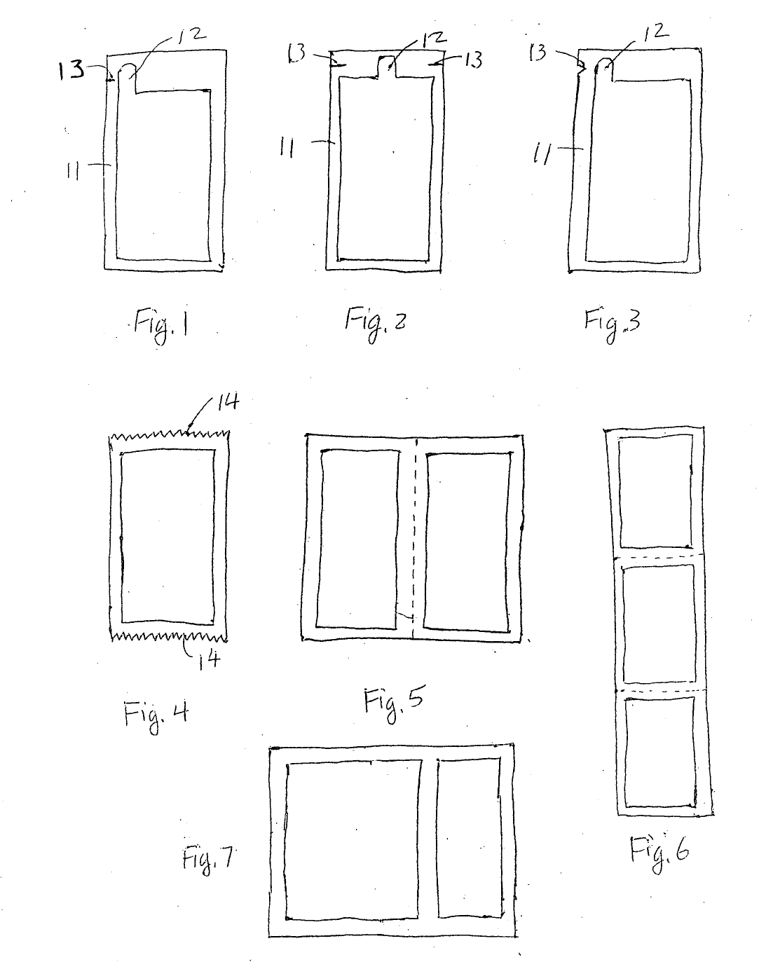

The liquid sweeteners are portion-packed in liquid packets. Each packet has a suitable amount of the liquid sweetener, for example, a net weight of around ¼ fl. oz. (target fill volume: Net. Wt. 23 oz (6.5 g)). Generally speaking, the liquid packet is sized to deliver a sweetness level of at least one teaspoon (1 tsp.) of sugar. The approximate dimensions of the packaging and the formed and filled area may be designed according to this dosage. In one type of construction, shown in FIGS. 1-7, the packets have a generally planner shape, with a suitable dimension such as approximately 1.875″×4.000″ (package width×package height). In another type of construction, shown in FIGS. 8-11, the packet is generally cylindrical in shape, but achieves comparable fill volumes, with a suitable dimension such as approximately 0.625″×4.000″ (package diameter×package height). There is a serration at the top of the package (not shown).

The packets are made of a material suitable for food condiments, such as a clear based plastic film. Generally, any suitable material and weight of the material may be used, so long as they provide a good oxygen and moisture barrier to protect the product's integrity and at the same time allow easy tear-ability to the consumer.

As shown in the drawing figures, the general construction of the liquid packets is a formed, filled, and sealed compartment with a built-in pour spout 12 to direct the flow of the content and one or more tear notches 13 to allow for easy tear-ability.

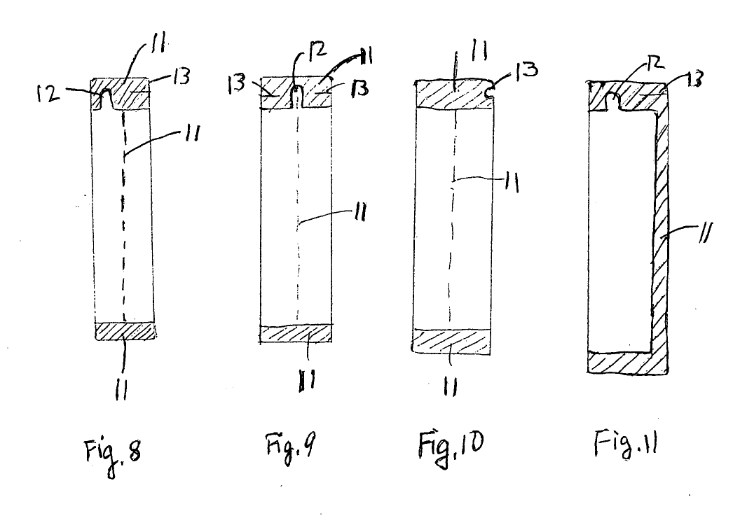

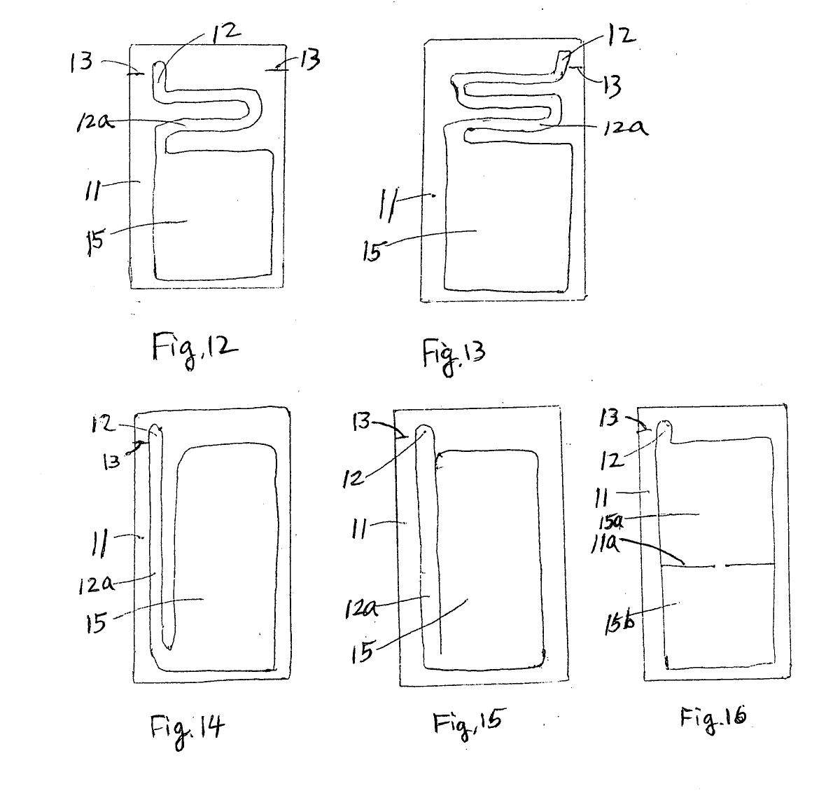

In the illustrated embodiments, the liquid sweetener is filled in a four-sided liquid packet. Seals 11 are provided at appropriate locations to seal the compartment. The sealing is done by a conventional heat sealing process. In the embodiments shown in FIGS. 1-7, seals 11 are provided on all four (4) sides to seal the compartment. In the embodiments shown in FIGS. 8-11, seals 11 are provided at three locations, including the top and bottom sides, and either the back or “spine” (see FIGS. 8-10) or the longitudinal side (see FIG. 11). The seals are preferably flat and not serrated (jig jagged) to prevent the consumers from tearing the package open from a place that would cause excessive spilling. A common example of a serrated packet is Heinz® ketchup packets. These packets have a jagged top and bottom seal 14 (see FIG. 4). The consumers tear the package open on either the top or bottom. The problem with this type of seal for a liquid sweetener is that the sweetener would then run down the side of the packaging as the consumer poured. To avoid excessive stickiness on the packaging and a mess for the consumer, the packet preferably has only flat seals, so that it is only easily torn open from the tear notch.

Each packet has a built-in pour spout 12, in the form of a narrower section of the fill compartment near an edge, to allow for easy pour-ability and directional flow. The pour spout 12 is preferably rounded and may be described as the “nipple” or “spout” of the packaging. The spout 12 has a length and a width appropriate for the size of the packet. The primary purpose of the pour spout is to give the consumer an easy to use tool, which helps direct the flow of the liquid sweetener into his/her drink of choice.

The pour spout 12 may be located near a corner of the packet (see, e.g., FIG. 1), or near the center of the top edge (see FIG. 2). In use, the user tears open the packet at the spout, and pours the content from the spout. To make it easy for the user to locate where to tear and assist in doing so, a tear notch 13 is provided on one or both side edges of the packet along a tear line that will cut through the spout when torn. An indication such as a dashed line may be printed on the packet to assist the user in locating and using the tear notch. In the case of a spout 12 located near a corner of the packet, the tear notch 13 is preferably provided on the side edge near the spout (see FIG. 1). This construction has the advantage of allowing the user to partially tear the packet, without completely tearing off a piece of the packet material, to open the spout and pour the content. Alternatively (not shown), the spout may also be provided on the side far from the spout, or on both sides. In the case of a spout 12 located near the center of the top edge, the tear notch(es) 13 may be provided on either or both side edges (see FIG. 2). This construction allows the user to easily tear the top section of the packaging off and proceed with pouring the content.

The width of the spout (i.e. the size of the opening when the packet is torn open) is preferably such that a thick liquid sweetener does not easily pour out, but requires some assistance by squeezing the package to cause it to pour out. This further helps preventing spilling of the content. The exact size of the spout is not important, so long as the above goal is achieved.

The tear notch may be a simple line cut in the edge of the packet (see FIGS. 1 and 2), or a V-shaped cut (see FIG. 3), or a U-shaped cut (see FIG. 10; a U-shaped cut may also be provided on a flat package such as the one shown in FIG. 3). The tear-notch is user friendly to both right and left-handed users.

As stated earlier, one aspect of the present invention is a generally planner shaped liquid packet as packaging for liquid sweetener or other appropriate ingestible and non-digestible liquid products. The packet may be one with a pour spout and tear notch described above, or a conventional one without pour spout such as the one shown in FIG. 4. In such a packet, the serrations are created by conventional serration tools, such as mold dies.

Further, a number of the liquid packets described above may be joined together to form, for example, a side-by-side twin pack with perforations (see FIG. 5, pour spout and tear notch not shown) or a bandoleer with perforations (see FIG. 6, pour spout and tear notch not shown). In addition, the liquid sweetener may be provided in a combination packaging that has one compartment for granular sweetener and another compartment for a liquid sweetener (see FIG. 7, pour spout and tear notch not shown).

The liquid packets may be optionally provided with a leak-prevention feature that prevents the remnants of the liquid from leaking out easily after the packet is opening and not all the liquid is used. As shown in FIGS. 12-15, a long and narrow fluid channel 12a connects the opening end of the pour spout 12 and the main compartment 15 of the packet. The fluid channel may be straight (FIGS. 14, 15) or meandering (FIGS. 12, 13) and may have any suitable length or shape. Due to such design, a degree of pressure will be required to squeeze the liquid out from the pour spout when pouring, and the liquid is less likely to leak out easily when the open packet is not in use. FIG. 16 shows an alternative design where the fluid compartment is divided by a seal 11a into two connected segments 15a and 15b. The unused liquid is likely to be trapped in the lower compartment 15b which prevents excessive leak.

It will be apparent to those skilled in the art that various modification and variations can be made in the liquid sweetener packaging of the present invention without departing from the spirit or scope of the invention.

What is claimed is:

1. A liquid sweetener package comprising:
a sealed package defining a liquid compartment and having a seal on one or more edges thereof, the liquid compartment having a narrower section near the seal on one edge to form a pour spout, the package further having a tear notch located near the pour spout; and
a liquid sweetener sealed inside the package.

2. The liquid sweetener package of claim 1, wherein the sealed package has a generally planner shape.

3. The liquid sweetener package of claim 1, wherein the sealed package has a generally cylindrical shape.

4. The liquid sweetener package of claim 1, wherein the package is made of a plastic film material and the seal is formed by heat sealing.

5. A package for a liquid condiment comprising two layers of a film material, the two layers being sealed at one or more sealed portions located near one or more edges to define a sealed liquid compartment, at least one sealed portion having a shape defining a long and narrow liquid channel formed by the two layers of film material, the liquid channel being connected to the liquid compartment.

6. The package of claim 5, wherein the liquid channel has a meandering shape.

7. A package for a liquid condiment comprising two layers of a film material, the two layers being sealed at one or more sealed portions located near one or more edges to define a sealed liquid compartment, the two layers further being sealed at a center portion to divide the liquid compartment into two connected sections.
